(19) United States
(12) Patent Application Publication
(10) Pub. No.: US 2006/0021367 A1
(43) Pub. Date: Feb. 2, 2006

(54) Oxygen enriched operator cab

(76) Inventors: Gail Leroy Detar, Erie, PA (US); Ajith Kuttannair Kumar, Erie, PA (US)

Correspondence Address: THE LAW OFFICES OF STEVEN MCHUGH, LLC, 46 WASHINGTON STREET, MIDDLETOWN, CT, 06457, US

(21) Appl. No.: 11/183,367

(22) Filed: Jul. 17, 2005

Related U.S. Application Data
(60) Provisional application No. 60/590,553, filed on Jul. 23, 2004.

(51) Int. Cl. B60H 1/32

(52) U.S. Cl. 62/244

(57) ABSTRACT

An oxygen distribution system for a railroad locomotive having an operator cab and operable at high latitudes in ambient air conditions having a low oxygen content level that would be hazardous to locomotive operators, with the oxygen distribution system being configured to generate and supply air having enriched oxygen content levels to the operator cab to support locomotive operators is provided and includes an O₂ generation device for generating O₂ gas, an O₂ processing device for mixing the O₂ gas and ambient air and a heating/ventilation device, wherein the O₂ generation device is in fluid flow communication with the heating/ventilation device via the O₂ processing device, with the O₂ processing device receiving O₂ gas from the O₂ generation device and processing the O₂ gas and ambient air to form a processed air having enriched oxygen content levels for transfer to the heating/ventilation device for distribution to the operator cab.

### RELATED APPLICATIONS

This application claims priority of U.S. Provisional Patent Application Serial Number 60/590,553 filed Jul. 23, 2004, the contents of which are incorporated herein by reference in its entirety.

### FIELD OF THE INVENTION

The present invention relates generally to a locomotive operating in an extreme environmental condition and, more particularly, to oxygenation of a locomotive cab operating in a low oxygen environment.

### BACKGROUND OF THE INVENTION

Locomotives that are used for heavy haul applications are well known and typically operate in extreme environments, including low oxygen environments at high altitudes. As such, these locomotives must provide critical life support systems, such as oxygenation devices, to sustain the life of the locomotive operator(s). To address this issue, current designs for locomotives operating at high altitudes generate oxygen and supply the oxygen to each member of the locomotive crew individually via masks worn over the mouth and nose of the crew member. Unfortunately however, this method of supplying life sustaining oxygen has several disadvantages associated with it.

One disadvantage involves the spread of bacteria and/or a virus from one crew member to another crew member. One reason for this is that situations may occur where more than one crew member may have to use one specific oxygen mask. This is undesirable because these oxygen masks are typically not sterilized after being used. Thus, if one person has a bacterial and/or a viral infection and wears the mask, it is highly probable that the inside of the mask (i.e. the part of the mask exposed to the nose and mouth of wearer) will be contaminated with the bacteria and/or virus, thus exposing the next person who wears this mask to the same infections. For example, if one crew member has an undiagnosed tuberculosis infection (a bacterial infection spread by aerosolization and expulsion of the tuberculosis bacteria from the lungs by coughing and breathing) and wears the mask, the inside of the mask will be contaminated with tuberculosis bacteria. As such, this will expose the next crew member who wears that mask to tuberculosis and may increase his/her probability of becoming infected with the bacteria.

Another disadvantage involves the discomfort and restriction of movement of the crew while wearing the mask. This is because the mask must be disposed securely over the nose and mouth of the wearer. As such, the mask must be snugly fastened to the wearer's face via a strap that wraps around the wearer's head causing the edge of the mask to press into the wearers' face. This is undesirable because after several hours of wearing this apparatus, a rash and/or bruise may form due to contact pressure between the edge of the mask and the wearer's face. Moreover, the mask must be attached to an oxygen generation device via a long hollow delivery tube which is used to deliver oxygen to the mask and thus the wearer. As the crew moves around the locomotive cab, the delivery tube is subject to kinking and/or becoming tangled in other delivery tubes and/or equipment. This is also undesirable because it may cause a dangerous situation by restricting the movement of the crew and/or by damaging a mask and/or delivery tube cutting off the oxygen supply to the crew member.

One way that has been investigated to address this problem involves supplying oxygen to the cab and pressuring the cab of the locomotive to assure sufficient oxygen, similar to that used in commercial airliners. Unfortunately however, this approach is not practical for locomotive cabs because the large flat panels of the cab are not sufficiently strong enough to resist the large forces generated by the small pressure differences caused by pressurization. Moreover, a locomotive cab requires doors and windows which are easily operated. In this case if the locomotive cab were a pressurized environment, the cab would have to undergo a pressurization/depressurization cycle every time a door or window is opened. This is undesirable because it increases the potential for injury of ear drums if a door or window is opened while the cab is pressurized.

### SUMMARY OF THE INVENTION

An oxygen distribution system for a railroad locomotive having an operator cab and operable at high latitudes in ambient air conditions having a low oxygen content level that would be hazardous to locomotive operators, with the oxygen distribution system being configured to generate and supply air having enriched oxygen content levels to the operator cab to support locomotive operators is provided and includes an O₂ generation device for generating O₂ gas, an O₂ processing device for mixing the O₂ gas and ambient air and a heating/ventilation device, wherein the O₂ generation device is in fluid flow communication with the heating/ventilation device via the O₂ processing device, with the O₂ processing device receiving O₂ gas from the O₂ generation device and processing the O₂ gas and ambient air to form a processed air having enriched oxygen content levels for transfer to the heating/ventilation device for distribution to the operator cab.

An oxygenated locomotive cab is provided and includes a locomotive cab structure defining a cab cavity for accommodating at least one person, wherein the cab structure includes a plurality of air ducts, wherein at least one of the plurality of air ducts is communicated with an oxygen distribution system, the oxygen distribution system including an O₂ generation device, an O₂ processing device and a heating/ventilation device, wherein the O₂ generation device is in fluid flow communication with the heating/ventilation device via the O₂ processing device, with the O₂ processing device receiving O₂ gas from the O₂ generation device and processing the O₂ gas and ambient air to form a processed air having enriched oxygen content levels for transfer to the heating/ventilation device for distribution to the cab cavity.

A method for providing O₂ to an operator cab of a locomotive, wherein the operator cab includes a cab environment which is at least partially sealed from an external environment is provided, wherein the method includes receiving ambient air having an O₂ content into an O₂ generation device, processing the ambient air to separate the O₂ content from the ambient air and to generate an O₂ flow between the O₂ generation device and the operator cab and conditioning the O₂ flow to control the atmosphere within the cab environment.

### BRIEF DESCRIPTION OF THE FIGURES

The foregoing and other features and advantages of the present invention will be more fully understood from the following detailed description of illustrative embodiments, taken in conjunction with the accompanying drawings in which like elements are numbered alike in the several Figures:

FIG. 1 is a schematic block diagram showing an exemplary embodiment of an oxygen distribution system; and

FIG. 2 is block diagram illustrating a method for providing O₂ to an operator cab of a locomotive.

### DETAILED DESCRIPTION OF THE INVENTION

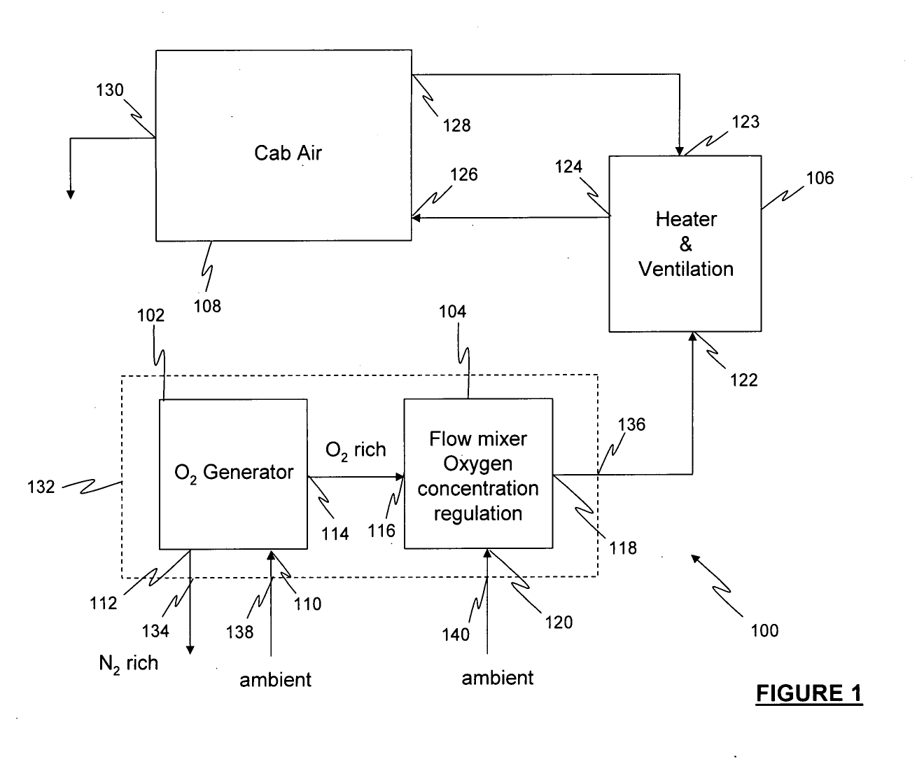

Referring to FIG. 1, a block diagram illustrating an oxygen distribution system 100 is shown and includes an oxygen generation device 102, a flow mixer/oxygen concentration regulation device 104 and a heater/ventilation device 106 communicated with a locomotive cab 108. Oxygen generation device 102 includes an ambient air inlet port 110, an N₂ outlet port 112 and an O₂ outlet port 114 and flow mixer/oxygen concentration regulation device 104 includes a flow mixer O₂ inlet port 116, a flow mixer outlet port 118 and a flow mixer ambient air inlet port 120. Furthermore, heater/ventilation device 106 includes a first heater/ventilation inlet port 122, a second heater/ventilation inlet port 123 and a heater/ventilation outlet port 124 and locomotive cab 108 includes a cab air inlet port 126 and a cab outlet port 128. Also shown in FIG. 1 is locomotive cab 108 having a ‘leak’ outlet port 130 which is meant to be representative of any leaks that may be present in the structure of locomotive cab 108.

As illustrated in FIG. 1, oxygen generation device 102 is disposed to be associated with flow mixer/oxygen concentration regulation device 104 within a system enclosure 132 which encloses oxygen generation device 102 and flow mixer/oxygen concentration regulation device 104 within an O₂ rich environment. As shown, system enclosure 132 may include a first system enclosure outlet port 134, a second system enclosure outlet port 136, a first system enclosure inlet port 138 and a second system enclosure inlet port 140. O₂ outlet port 114 is connected with flow mixer O₂ inlet port 116 such that O₂ generated by oxygen generation device 102 may be transferred to flow mixer/oxygen concentration regulation device 104. Additionally, ambient air inlet port 110 is communicated with first system enclosure inlet port 138 to allow oxygen generation device 102 to draw ambient air from the environment external to system enclosure 132. Moreover, N₂ outlet port 112 is communicated with first system enclosure outlet port 134 to allow oxygen generation device 102 to expel N₂ generated during the O₂ generation process into the environment external to system enclosure 132.

Furthermore, flow mixer outlet port 118 is communicated with second system enclosure outlet port 136 which is further communicated with first heater/ventilation inlet port 122 to allow the regulated oxygen from flow mixer/oxygen concentration regulation device 104 to be transferred to heater/ventilation device 106. Flow mixer ambient air inlet port 120 is communicated with second system enclosure inlet port 140 to allow flow mixer/oxygen concentration regulation device 104 to draw ambient air from the environment external to system enclosure 132. Heater/ventilation device 106 is communicated with cab air inlet port 126 and cab outlet port 128 via heater/ventilation output port 124 and second heater/ventilation input port 123, respectively. It should be appreciated that the environment surrounding the enclosed O₂ enriched environment is N₂ enriched.

Referring again to FIG. 1, oxygen distribution system 100 may operate as follows. Oxygen generation device 102 draws in ambient air via first system enclosure inlet port 138 and separates O₂ from the ambient air. The O₂ is then transferred to flow mixer/oxygen concentration regulation device 104 via O₂ outlet port 114 and the remaining components are expelled into the ambient environment via first system enclosure outlet port 134. Flow mixer/oxygen concentration regulation device 104 receives the O₂ via flow mixer O₂ inlet port 116 and combines the O₂ with ambient air drawn in from flow mixer ambient air inlet port 120 to create a resultant air having a predetermined ratio of O₂ and ambient air. This resultant air is then transferred to heater/ventilation device 106, at a predefined flow rate and mixture, via flow mixer outlet port 118 which heats the resultant air, as needed, to a predefined temperature. This resultant air is then transferred to locomotive cab 108 via heater/ventilation outlet port 124 where the resultant air is force fed into locomotive cab 108 by a plurality of cab inlet ducts. As the resultant air is being fed into locomotive cab 108, heater/ventilation device 106 receives cab air from locomotive cab 108 via second heater/ventilation inlet port 123. This cab air is then remixed with the resultant air and recirculated back into locomotive cab 108 at a predefined flow.

It should be appreciated that although resultant air created by flow mixer/oxygen concentration regulation device 104 is shown as being comprised of a 27% concentration of O₂ at ambient pressure, resultant air created by flow mixer/oxygen concentration regulation device 104 may be comprised of any O₂ concentration at any pressure, suitable to the desired end purpose. It should also be appreciated that although the resultant air created by flow mixer/oxygen concentration regulation device 104 is shown as being transferred to heater/ventilation device 106 at a flow rate of 30 Cubic Feet per Minute (CFM), any flow rate suitable to the desired end purpose may be used. Additionally, it should be appreciated that although the flow rate of air being transferred from heater/ventilation device 104 to locomotive cab 108 is shown at 400 CFM and the flow rate of air being transferred from locomotive cab 108 to heater/ventilation device 104 is shown at 370 CFM, any flow rate suitable to the desired end purpose may be used.

As can be seen, both oxygen generation device 102 and flow mixer/oxygen concentration regulation device 104 are shown as being configured to receive ambient air. Oxygen generation device 102 receives this ambient air from an oxygen generation device ambient inlet 110, separates out the N2 components and the O₂ components and exhausts the N2 component into the N2 rich environment and the O₂ component. Moreover, oxygen distribution system 100 may have sensor(s) external to and internal to locomotive cab 108 which senses oxygen content of the particular environment. This may allow oxygen distribution system 100 to automatically engage and/or disengage, in part or in whole, in a manner responsive to these sensor(s). It should also be appreciated that oxygen distribution system 100 may be operated remotely from a control communicated with oxygen distribution system 100 via any type of communication system suitable to the desired end purpose, such as via wireless communications. Moreover, it should be appreciated that oxygen distribution system 100 may be operated from any locomotive in the locomotive consist and as such, may be applied to all or only one locomotive in the consist.

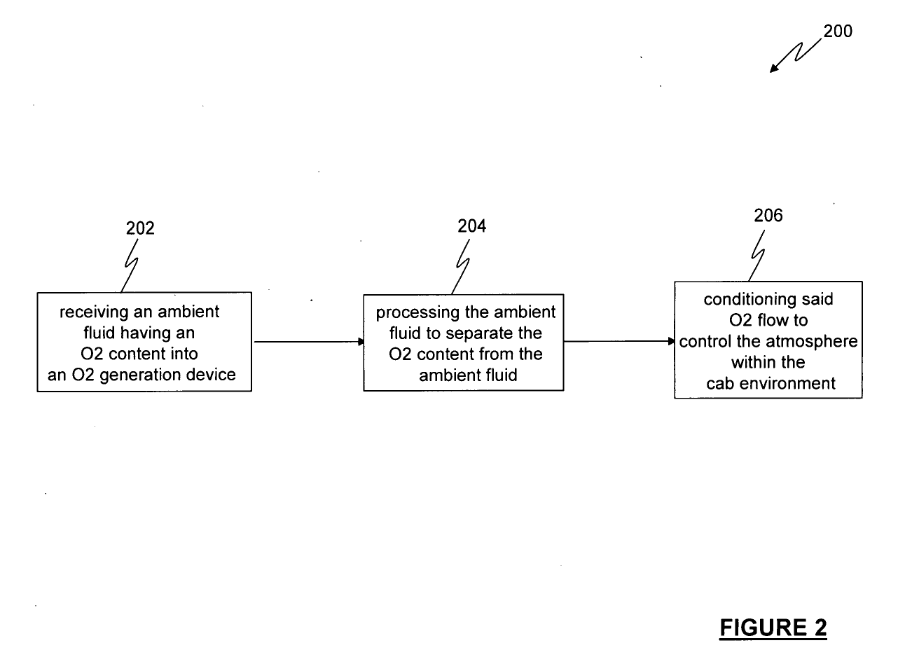

Referring to FIG. 2, a block diagram illustrating a method 200 for providing O₂ to an operator cab 108 of a locomotive, wherein the operator cab 108 includes a cab environment which is at least partially sealed from an external environment is shown. The locomotive includes an O₂ generator 102, a flow mixer/oxygen concentration regulation device 104 and a heater/ventilation device 106, wherein the heater/ventilation device 106 is communicated with the locomotive cab 108. The method 200 includes receiving an ambient fluid having an O₂ content, such as air, into the O₂ generator 102, as shown in operational block 202. The O₂ generator 102 processes the ambient fluid to separate the O₂ content from the ambient fluid and expels the ambient fluid into the external environment, as shown in operational block 204. An O₂ flow is then generated and the O₂ flow is directed to flow between the O₂ generation device 102 and the operator cab 108. Prior to reaching the operator cab 108, the O₂ flow is conditioned to control the atmosphere within the operator cab 108, as shown in operational block 206. The operator cab air may then be redirected back into the heater/ventilation device 106 which may heat the air and re-circulate the air back into the operator cab 108.

As described above, the method 200 of FIG. 2, in whole or in part, may be embodied in the form of computer-implemented processes and apparatuses for practicing those processes. The method 200 of FIG. 2, in whole or in part, may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Existing systems having reprogrammable storage (e.g., flash memory) may be updated to implement the method 200 of FIG. 2, in whole or in part.

Also as described above, the method 200 of FIG. 2, in whole or in part, may be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments may configure the microprocessor to create specific logic circuits.

It should be further appreciated that oxygen generation device 102 allows for the generation, conditioning (i.e. heated and/or filtered) and distribution of oxygen-rich air to be supplied to a locomotive cab, wherein oxygen generation device 102 supplies a flow of oxygen-rich air to the heating and ventilation system of the locomotive which distributes the enriched air to the locomotive cab through its duct work and several outlets. This is a desirable feature for heavy haul locomotives because these locomotives operate at elevations where the quantity of oxygen in the atmosphere is less than required for human occupation and survival. Oxygen generation device 100 allows crew personnel to move freely about the locomotive cab and/or to depart the cab as necessary. Because enriched air is introduced into the cab at several points in the cab and forcefully mixed with the entrained air of the cab, oxygen will be uniformly distributed about the locomotive cab. Additionally, because oxygen is forcefully mixed with the low oxygen content air of the locomotive cab, concentration of oxygen at all points of the distribution system and in the locomotive cab is enough to sustain human life but less than the oxygen at sea level. This eliminates any fire hazard which could exist due to high concentration of oxygen in proximity to burnable materials.

While the invention has been described with reference to an exemplary embodiment, it will be understood by those skilled in the art that various changes, omissions and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

What is claimed is:

1. An oxygen distribution system for a railroad locomotive having an operator cab and operable at high latitudes in ambient air conditions having a low oxygen content level that would be hazardous to locomotive operators, with the oxygen distribution system being configured to generate and supply air having enriched oxygen content levels to the operator cab to support locomotive operators, the oxygen distribution system comprising:
an O₂ generation device for generating O₂ gas;
an O₂ processing device for mixing the O₂ gas and ambient air; and
a heating/ventilation device, wherein said O₂ generation device is in fluid flow communication with said heating/ventilation device via the O₂ processing device, with the O₂ processing device receiving O₂ gas from said O₂ generation device and processing said O₂ gas and ambient air to form a processed air having enriched oxygen content levels for transfer to said heating/ventilation device for distribution to the operator cab.

2. The oxygen distribution system of claim 1, further comprising a primary oxygen distribution system electrical power source electrically connected to said railroad locomotive to receive electrical power from an electrical system on the railroad locomotive.

3. The oxygen distribution system of claim 1, further comprising an auxiliary oxygen distribution system electrical power source on the railroad locomotive, wherein said auxiliary oxygen distribution system electrical power source is a self-powered power source, so as to operate independently of the operation of the locomotive.

4. The oxygen distribution system of claim 1, further comprising an oxygen distribution system control device for controlling the operation of the oxygen distribution system.

5. The oxygen distribution system of claim 4, further comprising a sensor in communication with the operator cab for monitoring the level of oxygen within the operator cab and generating a signal for transmission to the control device.

6. The oxygen distribution system of claim 5, wherein said oxygen distribution system control device controls the O2 gas level in response to the signal from the sensor.

7. The oxygen distribution system of claim 1, wherein said O₂ processing device includes a flow mixer/oxygen concentration regulation device.

8. The oxygen distribution system of claim 1, wherein the operator cab includes at least one air outlet port and wherein said heating/ventilation device includes at least one air inlet port, said at least one air outlet port being communicated with said at least one air inlet port for communicating air in the operator cab back into said heating/ventilation device for recirculation into the operator cab.

9. The oxygen distribution system of claim 1, wherein said O₂ generation device includes at least one outlet port for discharge of N₂ gas generated during the O₂ generation process.

10. The oxygen distribution system of claim 1, wherein said heating/ventilation device is configurable to modify the temperature of said processed air to a predetermined temperature.

11. The oxygen distribution system of claim 7, wherein said flow mixer/oxygen concentration regulation device includes an ambient air inlet communicated with the ambient environment.

12. An oxygenated locomotive cab, comprising:
a locomotive cab structure defining a cab cavity for accommodating at least one person, wherein said cab structure includes a plurality of air ducts, wherein at least one of said plurality of air ducts is communicated with an oxygen distribution system, said oxygen distribution system including an O₂ generation device, an O₂ processing device and a heating/ventilation device, wherein said O₂ generation device is in fluid flow communication with said heating/ventilation device via the O₂ processing device, with the O₂ processing device receiving O₂ gas from said O₂ generation device and processing said O₂ gas and ambient air to form a processed air having enriched oxygen content levels for transfer to said heating/ventilation device for distribution to the cab cavity.

13. The oxygen distribution system of claim 12, wherein the locomotive cab includes at least one air outlet port and wherein said heating/ventilation device includes at least one air inlet port, said at least one air outlet port being communicated with said at least one air inlet port for communicating air in the locomotive cab back into said heating/ventilation device for recirculation into the locomotive cab.

14. The oxygenated locomotive cab of claim 12, further comprising an oxygen distribution system control device associated with a sensor, wherein said sensor is further associated with the locomotive cab for monitoring the level of oxygen within the locomotive cab and for generating sensor data responsive to the level of oxygen within the locomotive cab, wherein said oxygen distribution system control device controls the O₂ gas level in response to said sensor data.

15. A method for providing O₂ to an operator cab of a locomotive, wherein the operator cab includes a cab environment which is at least partially sealed from an external environment, the method comprising:
receiving ambient air having an O₂ content into an O₂ generation device;
processing said ambient air to separate said O₂ content from said ambient air and to generate an O₂ flow between said O₂ generation device and the operator cab; and
conditioning said O₂ flow to control the atmosphere within the cab environment.

16. The method of claim 15, wherein said receiving includes obtaining said ambient air from the external environment.

17. The method of claim 15, wherein said processing includes separating said O₂ content from said ambient air to generate a waste product via said O₂ generation device.

18. The method of claim 17, wherein said processing further includes expelling said waste product from said O₂ generation device.

19. The method of claim 16, wherein said conditioning includes modifying the temperature of said O₂ flow to a predetermined temperature and directing said O₂ flow into the operator cab.

20. The method of claim 15, wherein said conditioning further includes receiving an airflow from the operator cab, conditioning said airflow from the operator cab and re-circulating said conditioned airflow from the operator cab back into the operator cab.
